(19) United States
(12) Patent Application Publication
(10) Pub. No.: US 2002/0052895 A1
(43) Pub. Date: May 2, 2002

(54) Generalizer system and method

(76) Inventor: Brett Matthew Keating, San Rafael, CA (US)

Correspondence Address: Gray Cary Ware & Freidenrich LLP, 1755 Embarcadero Road, Palo Alto, CA, 94303, US

(21) Appl. No.: 09/977,010

(22) Filed: Oct. 11, 2001

Related U.S. Application Data
(60) Provisional application No. 60/240,437, filed on Oct. 13, 2000.

(51) Int. Cl. G06F 15/00

(52) U.S. Cl. 707/514

(57) ABSTRACT

A system and method for generalizing the content in a formatted document permits a group with multiple elements to be processed rapidly even if the number of elements in the group changes over time.

### BACKGROUND OF THE INVENTION

This invention relates generally to a system and method for generating a guide for processing various different input data and in particular to a system and method for generalizing a guide for the processing of input data wherein, despite changes to the input data, the guide may process the input data. In a preferred embodiment, the system may be used to determine a guide for processing an HTML or other formatted document despite changes to the formatted document.

It is desirable to be able to automatically process a formatted document into a different format. For example, when attempting to distribute one or more wireless web pages to one or more different wireless devices with one or more different screen sizes and the like, it is desirable to be able to process a web page automatically to generate the one or more wireless pages for the one or more different wireless devices using a guide. The problem with the automatic generating of the wireless web pages is that web pages are often not static. In other words, if the content and format of the HTML page does not change, then it may be referred to as static. On the other hand, if the content or format of the HTML page changes, it is dynamic and the guide that was used originally to process the HTML web page is useless once the web page has changed.

Thus, generalization is the process of applying the content selection and formatting of one element to other similar elements in the web page and being able to generate a guide that can handle when a web page is dynamic. In particular, generalization may take into account that elements targeted for generalization may occur an arbitrary number of times within an XHTML page. The results is that generalization forces the guide for the web page processing, such as XSL, to account for this by applying templates to similar elements in order to treat them in the same way. Today, there is no known method or system for performing this generalization process. To better understand the context of the generalization process, an overview of the evolution of different mark-up languages, their benefits and their drawbacks will be described briefly.

Standard Generalized Markup Language (SGML) created the first common standard for describing the structure and organization of an electronic document. SGML does not promote one specific structure, but rather allows for customized tag sets. As a result, it has become the primary basis of many more specialized programming languages. HTML (Hypertext Markup Language) and XML (Extensible Markup Language) were developed from SGML.

HTML was developed as the World Wide Web was coming to prominence. As hyperlinks became more common in site design, the hierarchical structure of documents became less important. The Web also gained more corporate and individual users. Reflecting this, HTML tags shifted focus to address the visual presentation of information rather than its structure. This was not altogether a successful shift, and browser and plug-in problems prompted the branching of HTML into different versions (HTML 4 and HTML Strict), which address presentational and structural issues separately.

As developers recognized that document presentation and structure required different tools, XML emerged. XML has become a powerful alternative on specialized tasks where HTML is difficult to use. While HTML offers a pre-defined set of tags, XML allows developers to define their own markup elements. Using XML, developers can store and structure document data in a manner tailored to their needs. Although the Hypertext Markup Language is the Web language of choice, it is problematic and limiting. XML solves many of the problems Web authors have experienced with HTML and is responsible for XHTML, a recasted HTML, in XML. Web authors and other publishers will be using XML for many years because it offers them an effective and powerful multi-media publishing solution. XML is designed to conform to authors needs, allowing Web documents a much greater level of structural and stylistic customization than has been traditionally allowed with HTML. XML is the result of an effort to make it possible to distribute Standard Generalized Markup Language documents over the Web. It is designed as a very small subset of SGML and fulfils the goals of the project. XML documents can be easily distributed and displayed on the Web, as can SGML documents that are made to conform to the XML subset. Independent of this goal, XML offers HTML developers, uninterested in the merits of SGML, a chance to customize and add proprietary elements to HTML.

XHTML (eXtensible HyperText Markup Language) is the first step toward a modular and extensible web, based on XML. It provides the bridge for web designers to enter the web of the future, while still being able to maintain compatibility with today's HTML 4 browsers. It is the reformulation of HTML 4 as an application of XML. It looks very much like HTML 4, with a few notable exceptions. Thus, if one is familiar with HTML 4, XHTML will be easy to learn and use. XHTML 1.0 was released on January 26th as a Recommendation by the W3C. XHTML is the major change to HTML since the introduction of version 4.0 in 1997. In effect, it reformulates HTML as an XML application. Hence, it can be viewed in HTML browsers as well as XML-based systems. The result is that web pages are accessible by almost anyone regardless of the browser device utilized to access the Web.

The XSL language permits user to alter and modify XML documents. In particular, XSL consists of two parts including a method for transforming XML documents and a method for formatting XML documents. XSL can be used to define how an XML file should be displayed by transforming the XML file into a format that is recognizable to a browser. One such format is HTML. Normally XSL does this by transforming each XML element into an HTML element. XSL can also add completely new elements into the output file or remove elements. It can rearrange and sort the elements, and test and make decisions about which elements to display, and a lot more.

RML is an application of XML, just as HTML and XML are applications of SGML. RML is tailored to the specific needs of the present assignee's application as described in the co-pending patent applications. Developers use RML's customized elements to add structural context to the content provided on a client Website. By converting HTML first to XML, then to RML, developers can structure data appropriately for a variety of presentation formats. Client data from requested URLs are retrieved and cached, then converted from HTML to RML via predefined rule sets. RML is used to create a “presentation shoe” appropriate for the wireless device. RML follows the structural rules for XML. However, the specific elements in RML are unique. The smallest unit of an RML document that encapsulates an idea is an atomic. Atomics contain data that is determined by the content provider (for Catalyst™, this is the client). They should contain an undividable amount of content. A paragraph of text, a heading, a link to a news story, or a picture could be an atomic. Developers modify every element by assigning attributes to the element. These attributes are used to determine how the element is displayed to the wireless device.

In one system used for generating a wireless web page (known as Nomad), a user takes data from an XHTML page and places it into some kind of an ARML structure. Typical ARML nodes are groups and atomics, just as in orthodox RML. By doing this, the user defines a structure that shows how the selected XHTML data are qualitatively related. In Nomad, the user will describe the qualitative relationships between various logical sets of data in the form of some ARML structure, and it is likely that each of the sets will be entirely contained within it's own ARML group. If the number of such logical groups of data changes from page to page or from time to time, the user cannot be expected to rework so as to change the number of ARML groups in their wireless page, especially since it is possible to write XSL that can handle changing numbers of qualitatively related data sets in XML. In addition, without generalization it would be impossible for a user to make something wireless inherently dynamic, like a search page.

The problem is then how to allow users to specify which ARML nodes might need to change in number as the XHTML changes. In addition, how can the user input be properly converted into the correct guide (e.g., XSL)? This is the problem of generalization. Thus it is necessary to come up with an innovative generalization system and method that overcomes the above problems and limitations and it is to this end that the present invention is directed.

### SUMMARY OF THE INVENTION

The generalization system and method in accordance with the invention solves the above problems and permits similar elements in a web page to be treated in the same manner so that a dynamic web page may be processed using the guide. In particular, an element may occur an arbitrary number of times in the web page without disrupting the automatic processing using the guide. For example, a newspaper home web page may have one or more top newstories. If an extra top newstory is added to the home web page, the guide intended to process the original home page will also automatically process the home page with the extra top newstory.

In more detail, the generalization system and method involves a combination of user input and automatic processing and computation. In this method, the user selects an example of a type of group or atomic that may dynamically change in number and then adjusts the amount of content that is represented by the element. For example, the user may elect to remove certain elements from the new selected content or to move further up or down the XHTML tree to make the content selection larger or smaller. The user then views the selection and either approves the change or provides more input. In a preferred embodiment, the goal of the generalizer is to compute XPath expressions that represent a set of selected nodes in an XHTML page, the number of which might change from page to page or from time to time.

Thus, in accordance with the invention, a system and method for generalizing a set of varying number of atomics and/or groups in a hierarchical document structure (e.g., XHTML or XML) is provided. The method may include identifying an anchor node where the anchor node is defined as the context XHTML node of the XSL template for a particular RML node and identifying an anchor node parent with sibling delimiters where, each item shares the same parent. However, if there are other items that are identical and also share the same parent, they should not be included. The method further comprises identifying an anchor node sibling where each individual area of generalized structure is not capable of being contained underneath its own unique ancestor node. Typically, this occurs when each of the examples spans several nodes underneath a parent common to all of them. In this case, the anchor node is not a parent of all of the remaining XPath expressions within the template. Instead, the anchor node is a sibling to the first node in each XPath. The method further comprises identifying an anchor node sibling with tangling where due to the way tables are structured in HTML, it is easy for structured areas that are divided into rows and columns to become tangled. With the above methods, the generalizer could easily handle generalization of individual rows or individual columns. However, generalization of tabled data posed a problem because the anchor node computed happened to be shared by multiple examples. This caused the general XPath expressions within the template to match more than one item.

The method further comprises generating an XPath expression that represent a set of selected nodes in an XHTML page, the number of which might change from page to page or from time to time, and generating a generalized XPath expression for a set of atomics and/or groups in an XHTML page.

### BRIEF DESCRIPTION OF THE DRAWINGS

FIG. 1 is a diagram illustrating an embodiment of the generalizer system and method implemented on a typical computer system;

FIGS. 2A and 2B are diagrams illustrating the generalizer system incorporated into a wireless web page generation system;

FIG. 3 illustrates an example of generalization;

FIG. 4 illustrates a context node;

FIG. 5 illustrates an embodiment of a generalizer method in accordance with the invention;

FIG. 6 illustrates more details of the path combiner step of the method shown in FIG. 5;

FIG. 7 illustrates more details of the node untangler step of the method shown in FIG. 5;

FIGS. 8A-8C illustrate a first generalizer example for generalizing atomics within a group in accordance with the invention;

FIGS. 9A-9C illustrate a second generalizer example for generalizing atomics within a group (multiple groups) in accordance with the invention;

FIGS. 10A-10C illustrates more details of the second example of the generalization shown in FIGS. 9A and 9B;

FIGS. 11A-11D illustrate a third generalizer example for generalizing multiple groups in a row-wise manner in accordance with the invention;

FIGS. 12A-12C illustrate a fourth generalizer example for generalizing multiple groups in a column-wise manner in accordance with the invention;

FIGS. 13A-13D illustrate a fifth generalizer example for generalizing multiple groups with multiple atomics using diagonal generalization in accordance with the invention;

FIGS. 14A-14D illustrate a sixth generalizer example for generalizing multiple groups with multiple atomics using nested generalization in accordance with the invention; and

FIG. 15 illustrate a seventh generalizer example for generalizing multilevel nested generalization with any combinations in accordance with the invention.

### DETAILED DESCRIPTION OF A PREFERRED EMBODIMENT

The invention is particularly applicable to the generalizing of a guide, such as an XSL stylesheet, for processing similar elements in a web page for purposes of generating wireless web pages for one or more different wireless devices and it is in this context that the invention will be described. It will be appreciated, however, that the system and method in accordance with the invention has greater utility, such as to different formatted documents or files where it is advantageous to be able to automatically process them despite changes to the documents or files.

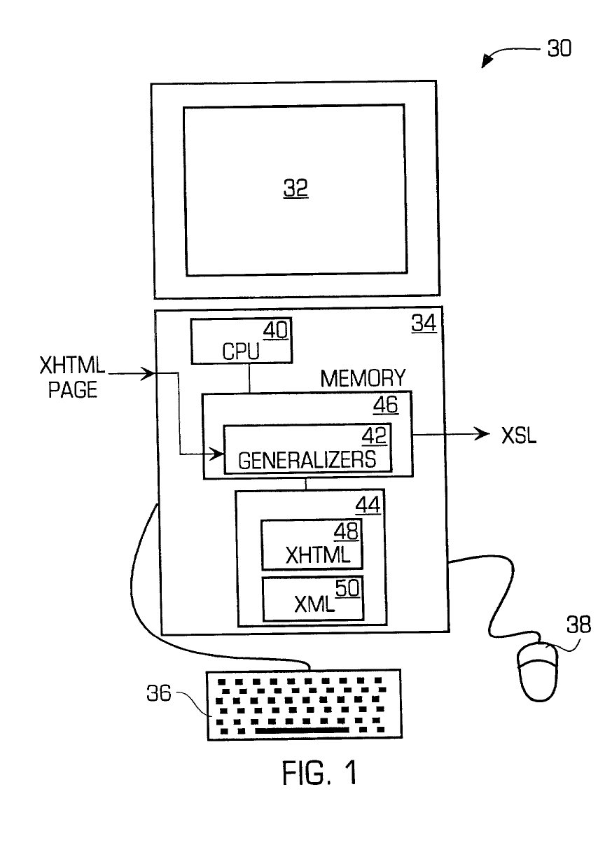

FIG. 1 is a diagram illustrating an embodiment of the generalizer system 30 implemented on a typical computer system. In particular, the system 30 may include a display unit 32, such as a cathode ray tube or the like, a chassis 34 and one or more input/output devices, such as a keyboard 36 or mouse 38 or other devices, such as a printer. The input/output devices permit the user to interact with the computer. The chassis may further include a central processing unit (CPU) 40 that controls the operation of the computer and executes one or more software applications. The chassis may further include a memory 42 for the temporary storage of software applications being executed by the CPU and a persistent storage device 44 for the permanent storage of software applications and data. In this example, a generalizer application 46 may be loaded into the memory 42 so that the CPU may execute the instructions embodied in the generalizer software in order to perform the functions of the generalizer system and method. Although a software embodiment of the generalizer system is shown, the system may also be implemented in hardware. In general, the system processes an incoming formatted document of file, such as in the HTML, XHTML, XML or other formats to generate a tree of objects associated with the formatted document. Using the tree structure, the generalizer system attempts to generalize the processing rules applied to the formatted document into a processing guide, such as an XSL stylesheet, so that similar elements are processed in the same manner. Thus, the element may appear an arbitrary number of times in the formatted document and may still be processed correctly using the guide with generalized processing rules. In a preferred embodiment, the generalizer system may be used in conjunction with a wireless web page development system that will now be briefly described to better illustrate the invention. However, the generalizer system and method in accordance with the invention is not limited to the preferred embodiment since it may be used to generate guides for various different formatted documents.

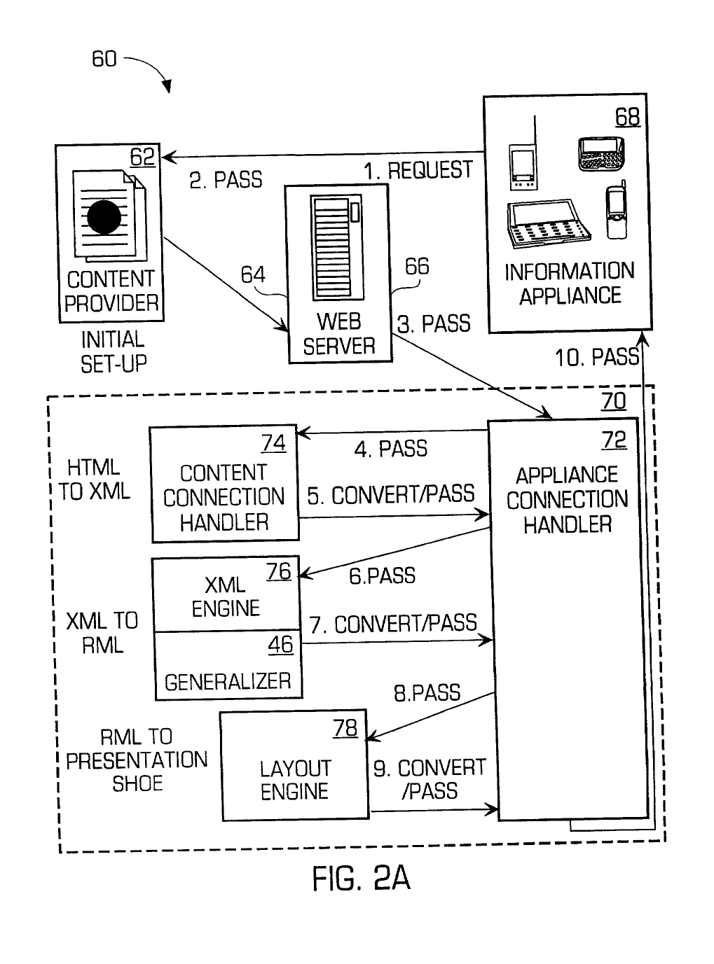

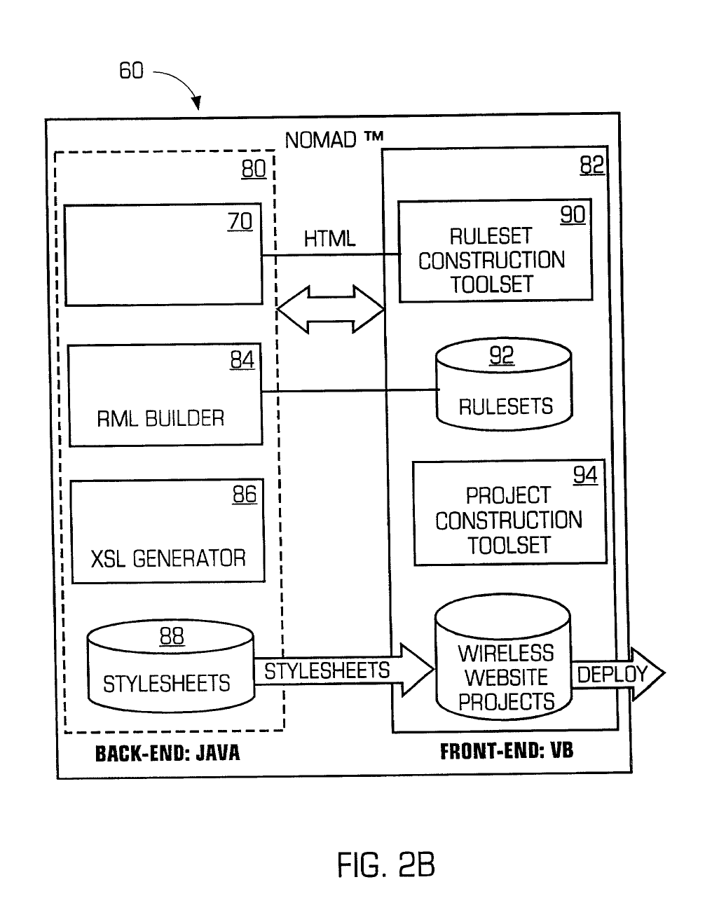

FIG. 2A is a diagram illustrating the generalizer system 46 incorporated into a wireless web page generation and delivery system 60. A brief description of the system will be described herein. A more detailed description may be found in co-pending U.S. patent application Ser. No. 09/503,797 filed on Feb. 14, 2000 which is owned by the same assignee as the present invention and which is incorporated herein by reference. The system 60 may include one or more content providers or information sources 62, such as companies that would like to be able to deliver their web pages from a web site to one or more different wireless devices wherein each wireless device may require the web page to be formatted in a particular manner due to the size of the screen of the wireless device, the memory of the wireless device or the communications link between the wireless device and the web site.

The system may also include a gateway 64, a web server 66, a wireless communications system 68 to the wireless device and a wireless web page delivery portion 70. The gateway may intercept an incoming HTTP request from a wireless device and route the request to the web server 66 and on to the wireless page delivery portion 70. The wireless page delivery portion 70 may retrieve the actual requested HTML page, reformat the page into one or more cards and decks for the particular wireless device and send the reformatted cards and decks to the wireless device using the web server 64 and the gateway 66.

To carry out the reformatting of the HTML page and other functions, the wireless page delivery portion 70 may further include an appliance connection handler 72, a content connection handler 74, an XML engine 76 and a layout engine 78 wherein the XML engine and the layout engine may includes a rules database and an XSL ruleset database (not shown). Briefly, the system may receive the incoming HTML page request, retrieve the web page, reformat the HTML page into XHTML, generate an RML document from the XHTML document, format the elements from the RML document into one or more cards and decks to form a presentation shoe that is delivered to the wireless device. The interactions of the portions of the wireless page delivery system are shown in FIG. 1 in more detail and further described in the above incorporated co-pending patent application. Therefore, the operation of the wireless page delivery system will not be described in any more detail. The above shows a system that may use the generalizer system and method in accordance with the invention in order to effectively process HTML pages even when those pages change.

FIG. 2B is a block diagram illustrating a wireless web page generation system 60 in accordance with the invention. Generally, the web page generation system permits a producer or company with a web site to control the look of its one or more web page when the web pages are downloaded to a wireless device as will be described in more detail below. The wireless web page generation system 60 may include a back-end portion 80 and a front-end portion 82. The front-end portion may also be referred to as a graphical user interface (GUI) tool. In a preferred embodiment of the invention, the back-end portion may include one or more compiled JAVA programs/modules that implement the functions of the back-end as described in more detail below and the front-end may be one or more Visual Basic modules/programs that implement the functions of the front-end (GUI Tool) as described in more detail below. The GUI tool and the back-end may be connected to each other using APIs as is well known.

In more detail, the back-end 80 may further include the web page delivery portion 70 shown in FIG. 1, an RML builder module 84, an XSL generator module 86 and a stylesheet database 88. The function of each module will be described herein and a more detailed description of each module will be provided below. As described above, the web page delivery portion 70 may generate XHMTL. The RML builder module 84 may generate an RML document based on a generated ruleset as described in more detail in the incorporated co-pending patent application and output the RML document into the XSL generator 86 that generates an XSL stylesheet based on the RML document. The generation of the XSL stylesheet may be accomplished with the generalizer system and method in accordance with the invention. The generated stylesheet may be stored in the database 88. The XSL stylesheet may be used to automatically generate one or more cards from a web page so that the web page may be downloaded and displayed on a wireless device.

The GUI tool 82 may further include a ruleset construction toolset 90, a ruleset database 92, a project construction toolset 94 and a wireless website projects database 96. The Graphical User Interface (GUI) tool enables the user to interact with the application. In particular, using the GUI tool, the user can perform content selections, configuration and deployment for their wireless website project including defining the one or more cards that contain the content of the web site. In a preferred embodiment, the GUI has the look and feel of standard MS Windows-type application, and conforms to MS Windows applications standards.

The ruleset construction toolset 90 may permit the user to create and define rulesets. A ruleset expresses how the wireless page delivery system 70 should transform the content and services from a desktop-centric webpage into one or more cards destined for a wireless device such as the new formatting for the cards and which content goes on which card. In more detail, a ruleset may also define which URLs use a particular ruleset. The ruleset may also include an XSL stylesheet that specifies how the web page is transformed into one or more wireless pages. Using the ruleset construction toolset, a user can:

1. Create, open, and save rulesets;

2. Select a desktop-centric webpage on which to base a ruleset;

3. Configure a ruleset (select and group the content and services for a web page for wireless delivery);

4. Integrate specialized wireless features into the ruleset;

5. Graphically view the Wireless Navigation Structure of the ruleset; and

6. Deploy the ruleset for testing purposes using a wireless device emulator or an internet-enabled wireless device.

The ruleset construction toolset 90 may receive the XHTML document representing a web page from the web delivery portion 70 and generate one or more rulesets based on the XHTML that maybe stored in the database 92. The one or more rulesets, as described below in more detail, determine how the HTML web page will look on the wireless devices when the web page is converted into the wireless web page. The rulesets in the database 92 may be sent to the RML builder 84 that generates the RML document and it may also be sent to the project construction toolset 94 that generates the wireless website projects for the incoming web pages as described below. The finished projects are stored in the database 96.

In operation, a producer may interact with the GUI tool to generate a wireless website project which includes information about the look of the HTML web page on the one or more wireless devices. When the producer or user selects a web page, the wireless delivery portion 70 may retrieve that web page and generate an XHMTL document corresponding to the web page. Using the ruleset construction toolset, the user may extract or automatically extract one or more elements from the web page. From the extracted elements, known as atomics hereinafter, the user may generate the look of the wireless pages and review the wireless pages. Once the user is satisfied with the wireless pages, one or more rulesets are generated that capture the information about the look of the wireless pages so that the wireless page delivery system 70 (See FIG. 1), when it receives a request for a web page, automatically generate the appropriate one or more cards for the wireless device based on the generated rulesets and stylesheets. Thus, once the user defines the rulesets and stylesheets, the wireless page delivery system automatically generates the wireless pages in accordance with the stylesheets.

Using the generated rulesets, the RML builder module 84 and the XSL generator module 86 may generate an RML document and then generate an XSL stylesheet that reflects the producer's requirements as embodied in the rulesets and the RML document. The ruleset may also be used to generate project information that may be combined with the XSL stylesheet to generate a wireless website project that may then be deployed using the wireless web page delivery system as shown in FIG. 1. Using the wireless page generation system, the user may specify the format of its web pages on the wireless devices.

The above system is an example of the environment in which the generalizer system and method in accordance with the invention may be used. The above example provides context for the terms used below and therefore the above example will be used throughout the application to describe the invention although the invention has broader applicability to any formatted document. Now, an example of the generalization problem will be described.

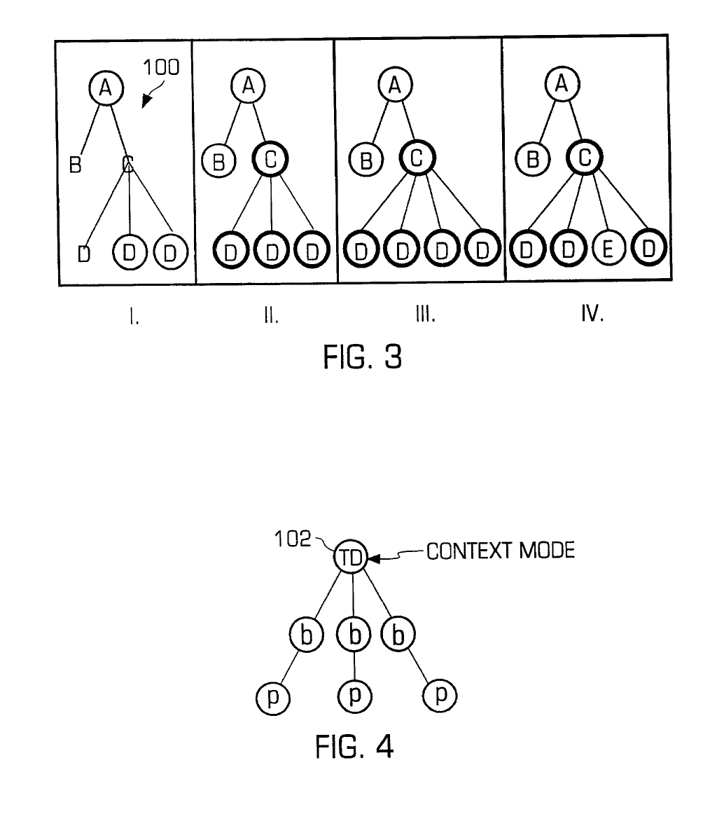

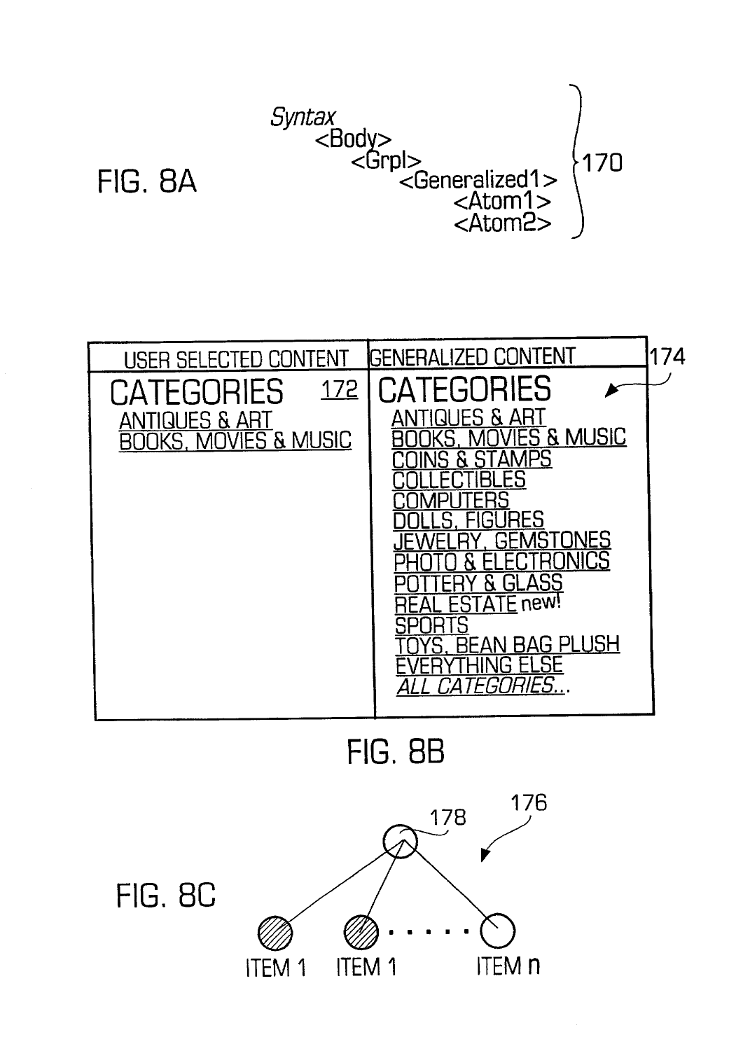

FIG. 3 illustrates an example of generalization and a simple scenario that is handled by the generalizer system and method in accordance with the invention. As shown, a web page or other formatted document has been broken down into one or more objects, such as a XHTML structure, in a tree 100. As shown, the tree may include a root node, A, with child nodes B and C wherein C has three child nodes that are all labeled “D”. Now, suppose a user wants to “generalize” the “D” nodes whose numbers may vary from time to time so that a processing guide may locate the “D” nodes regardless of the number of D nodes. In this example, the “D” node has a “C” tag as its parent in the XHTML structure. The D node may be generalized by selecting two “D” nodes (atomics shown as circled) and inserting a ‘generalized’ tag for this group (as described in more detail below in FIGS. 8A and 8B). If the “C” tag has several “D” tags underneath it, all the “D” tags will be converted into atomics and will be “generalized.” Thus, the generalizer method and system handles a change in number of children. A similar method in accordance with the invention may be used to handle the generalization of groups of atomics or nodes. After the node selection is made, the front-end passes an Agnostic RML structure to the XPath PreProcessor (not shown in FIGS. 2A or 2B, but located in the XSL generator 86). The XPath PreProcessor may then compute a single general XPath expression that uniquely identifies each generalized set of nodes.

There are several problems in generalization as it relates to how the XHTML happens to get organized into an ARML structure. The ARML essentially contains a mapping from the XHTML structure into another structure, RML. This mapping can take many forms. For example, the mapping information is also contained in the XSL stylesheet used to map XHTML into RML. However, since ARML contains the identical hierarchical structure as the target RML, it is usually adequate to say that the organization of XHTML pieces into an ARML structure is equivalent to the same organization into an RML structure.

Generalized nodes are interesting because a single template (XSL Stylesheet) handles the creation of all instances of that node in the target RML. Any XPath expression is capable of representing more than one node. The set of nodes the XPath expression represents is often called a nodeset. As shown in FIG. 4, the XPath expression b/p could potentially match several paragraphs from the td node depending on the contents of the XHTML. There could, for example, be three paragraphs (“p”) connected to the td node through a b tag as shown in the FIG. 4.

An anchor node 102 (as shown in FIG. 4) is defined as the context XHTML node of the XSL template for a particular RML node. This is the XHTML node that is matched in order to begin construction of the corresponding RML node, and the XSL code within the template is responsible for extracting the desired content from the XHTML and placing it within the RML node. The concept of a context node is something inherent to XSL. The concept of an anchor node is essentially equivalent, however it is more specific because it is tied to the concept of mapping from XHTML to RML. Now, the general operation of the generalizer method in accordance with the invention will be described.

In order to generalize a group of elements (also referred to an atomics) or an atomic, the anchor node may be generalized. As stated earlier, the anchor node is the context node, and it is thus the XHTML node from which the remainder of the XHTML to be used in the mapping can be referenced. Based upon the example mappings, the generalizer first decides how those mappings are anchored. In other words, the question to answer is, which XHTML node should be used as the context node of the XSL template that produces this RML node? Once that has been decided, the method may then search the XHTML code to find the anchor node for each instance of the XHTML structure. Finally, a generalized XPath expression is computed which matches all of them.

Once the general XPath expression has been computed, it is used to call the template for creating the group or atomic. In XSL, if we call a template using an XPath expression that matches more than one node, the template code gets run a number of times equal to the number of nodes in the nodeset described by the XPath expression. Thus, if we call the template using an XPath expression that matches 3 nodes, the template gets called 3 times, and a different node in the nodeset is used as the context node each time it is executed.

Therefore, once the generalizer has computed a general XPath expression, it can call a template for the creation of a certain type of group or atomic equal to the number of times a certain XHTML node structure appears in an XHTML page. Thus, in essence, the generalizer produces an XSL Template which creates a certain RML node and it gets called a number of times equal to however many instances of the corresponding XHTML structure occur.

When the generalization method is used, the hierarchical structure of the ARML is slightly different from the RML. The ARML and the RML will differ in structure in the case of generalized regions. This is because the ARML only contains a handful of examples of restructured XHTML, while the RML should contain all of them for a given page. For generalization, it is impossible to have the two match for the simple fact that the ARML is not dynamically created, while the RML is. If the number of groups or atomics changes in the RML due to dynamism in the XHTML, this cannot be identically reflected in the ARML, which is really just a static set of instructions for the creation of a stylesheet.

In addition, the mapping given by the ARML in the case of generalization is incomplete. The goal of the generalizer is to compute the correct mapping and place it in the XSL, given several examples of sections in the XHTML that need to be mapped into a particular RML substructure specified by the user. However, when the information used to compute the mapping is still in its ARML form, the item-by-item correspondence between an RML node and its XHTML is not present. Now, the generalizer method in accordance with the invention will be described.

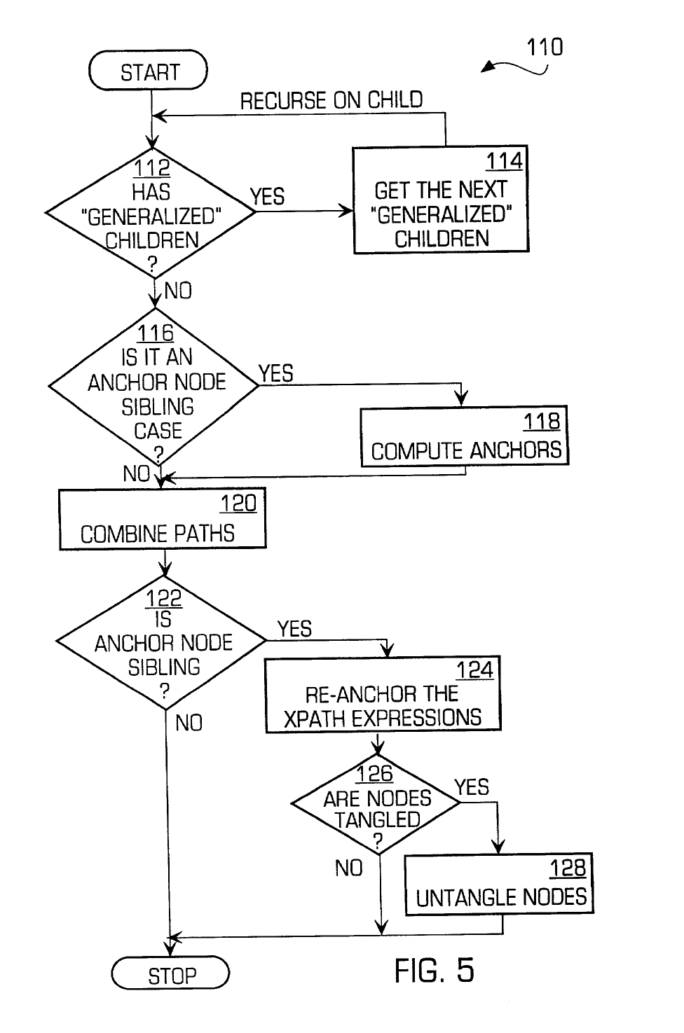

FIG. 5 illustrates an embodiment of a generalizer method 110 in accordance with the invention. In step 112, the method may determine if the current node being processed has any “generalized” children. If it does have generalized children, then the method goes to step 114 in which the next generalized child is retrieved and the method recurses on the child to find other children or grandchildren (nested) that are generalized. As mentioned earlier, the generalization algorithm allows for nested generalization. It is a simple recursion, which processes generalization nodes in a bottom-up fashion. This reduces the problem of generalization to a two-case problem, where the generalization algorithm is dealing with either 1) paths which have not yet been generalized or 2) paths which have already been generalized. This avoids the problem of trying to generalize structures, which contain generalized nodes within them.

If the node does not have any generalized children, then the method determines if this is a case of anchor node sibling or not in step 116. This may be detected in the XPathPreProcessor class. In particular, each ARML node has an “xhtmlpath” computed for it, which is the reference point from which all paths inside the node are defined. If the set of nodes to be generalized all end up with empty xhtmlpaths after pre-processing, then it is a case of anchor node sibling. This is because the xhtmlpath of the generalized node becomes relativized to be the common parent of all children of the example nodes, which means this cannot be used as an anchor.

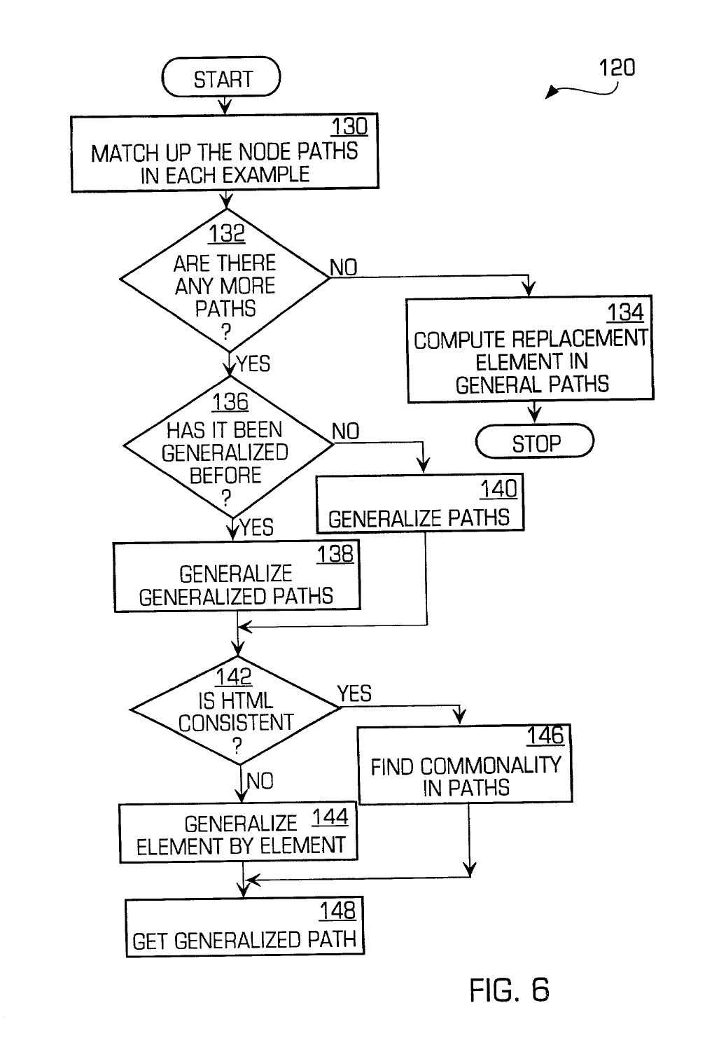

If there is an anchor node sibling, then the method computes the anchors in step 118. Otherwise, the next step involves actually generalizing (combining) the paths in step 120. It is a requirement that the structure should be identical in all examples so there will be the same number of paths in each and they will occur in the same locations. These paths are matched up into sets across the examples so that all paths that occur in the same location in the examples are grouped/combined together. This set of paths is sent to a path-combining method, that is described below with reference to FIG. 6, that computes a generalized XPath expression that matches all of them.

The next step in the generalization method after the paths have been combined is to re-anchor and untangle the replacement node if necessary. Thus, in step 122, the method determines if the anchor node is a sibling. If the anchor node is sibling, the reanchoring and untangling of that node if needed is carried out. Re-anchoring is a simple matter in that the paths need to be made relative to a different node by using following-sibling and previous-sibling axes in step 124. However, if there is a case of anchor-node-parent inside of a case of anchor-node-sibling during a nested generalization, the interior nodes will have an anchor node higher in the tree than the exterior node' anchor nodes. In that case, special handling is required to re-anchor the interior anchor-node parent cases to siblings and use the sibling anchor nodes as delimiters to generalize between. This is the case of anchor node parent with sibling delimiters.

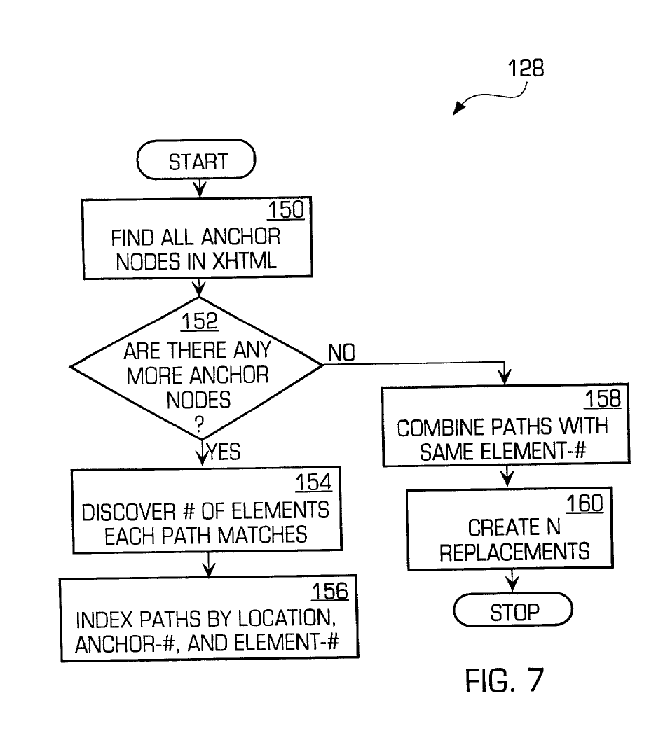

Untangling is a problem that sometimes results when generalizing tabled structures. In step 126, the method may determine if there are any tangled nodes and then untangle any tangled nodes in step 128. The untangler method is described in more detail with respect to FIG. 7. The problem manifests itself by generalized paths matching more than one item from each anchor node. In generalization, the idea is to create a general expression for a set of anchor nodes, but from each anchor node have very specific paths to the interior content pieces. So, if any interior path matches more than one item, there is a structural inconsistency and the structure that the user specified will not be represented in the RML output. These nodes need to be untangled by first counting the number of items each interior path matches as described below.

Once the generalization has proceeded through all the above steps, the replacements (or set of replacements for the case of untangling) are returned into the tree, replacing the generalized tag. The XSL writer then handles these as normal, without caring what the XPath expressions contain or whether they've been generalized to. Now, the path combining method in accordance with the invention will be described in more detail.

FIG. 6 illustrates more details of the path combiner step 120 of the method shown in FIG. 5. In particular, in step 130, the path combiner may match up the node path in each example. There are four cases, based on whether either of the following two statements are true: 1) the paths have been generalized before; and 2) the HTML is inconsistent as will be described. In step 132, the method determines if there are more paths. If there are no more paths, then the method may compute the replacement element in the general paths and the path combiner method has been completed. If there are more paths, the method may determine if the paths have been generalized before in step 136. If the paths have been generalized before, it becomes more difficult to do that and instead the previously computed predicates are compared and concatenated with an ‘or’ operator to generalize the paths in step 140. If the paths have not been generalized before, it is a simple matter to attempt to take the HTML into consideration and try to find common attributes of nodes present in the paths in step 142.

In step 142, the method determines if the HTML is consistent. If the HTML is not consistent, the paths can be generalized on a step-by-step basis, considering each of the path elements independent of the rest in step 144. Otherwise, a method may figure out to what extent they are consistent and use set logic to figure out what is common between the paths for the remaining inconsistent part in step 146. That part of the algorithm relies upon an XSLT extension. In step 148, the generalized path are retrieved and the method is completed. Now, the node untangler method in accordance with the invention will be described in more detail.

FIG. 7 illustrates more details of the node untangler step 128 of the method shown in FIG. 5. In particular, as described above, the untangling problem manifests itself by generalized paths matching more than one item from each anchor node. Thus, these nodes need to be untangled by first counting the number of items each interior path matches. For a tangled node, the interior nodes will all match the same number of items. These paths are re-generalized by recovering the original paths to the examples, enumerating them by 1) the anchor node they are relative to, 2) the location of the path in the example structure, and 3) the item number. Then, for each coordinate of (path,item) the paths are generalized across all anchor nodes. Then a number of replacements are used instead of just one, and this number is equal to the number of item numbers the tangled paths pointed to. In more detail, in step 150, the method may find all anchor nodes in the XHTML. In step 152, the method determines if there are any more anchor nodes. If there are more anchor nodes, then the method discovers the number of elements in each of the path matches in step 154 and indexes the paths by the location, anchor number and element number is step 156. The method then loops back to step 152 to determine if there are more anchor nodes.

If there are no more anchor nodes, then the method may combine the paths with the same element numbers in step 158 and create a predetermined number, N, of replacement elements in step 160. Thus, the untangling process in accordance with the invention is completed. Now, several examples of atomics or groups of atomics that may be generalized in accordance with the invention will be described to help better understand the invention.

In operation, a user may select an atomic or groups of atomics as examples of the groups or atomics that should be generalized. Based on the examples provided by a user and how these examples organize sections of XHTML, there are several very useful cases of how the generalizer should proceed in computing the mapping. These include:

Case 1. Generalizing atomics within a group (with a single group)

Case 2. Generalizing atomics within a group (with multiple groups)

Case 3. Generalizing multiple groups (each with multiple atomics), Row-wise generalization

Case 4. Generalizing multiple groups (each with multiple atomics), Column-wise generalization

Case 5. Generalizing multiple groups (each with multiple atomics), Diagonal generalization

Case 6. Generalizing multiple groups (each with generalized multiple atomics)—Nested generalization

Case 7. Generalizing any combination of atomics, groups, generalized atomics and generalized groups, including multi-level nested generalization

Each one of these cases is discussed below with examples. There are a few other cases where generalizer can also be employed, but since these are rather uncommon or exceptions, they are not discussed here. The first case is the generalization of atomics within a single group.

FIGS. 8A-8C illustrate a first generalizer example for generalizing atomics within a group in accordance with the invention. For each example, the syntax of the elements is provided, an example of the selected elements by the user and a graphical example of the generalization occurring is shown. For example, with respect to case 1, FIG. 8a illustrates a syntax 170 for atomics within a single group. As shown, there may be a body portion that includes a group 1 tag (<Grp1>) that includes a generalized tag (<Generalized1>) that in turn includes two atomics (<Atom1> and <Atom2>).

In accordance with the invention, the user must select at least two atomics in the group to generalize. FIG. 8B illustrates user selected content 172 and generalized content 174. As shown, the user has selected at least two atomics (e.g., “Antiques & Art” and “Books, Movies & Music”) in the group (e.g., “Categories” in this example). FIG. 8C illustrates a graphical tree 176 wherein the user has selected at least two atomics (shown shaded) for one or more atomics (n in this example) within a group node 178. This is the simplest case of generalization where a single group (‘Categories’ in this case) consisting of a varying number of items (atomics) is generalized. In operation, a user selects two items from the list of items and puts them under a generalized tag. The generalizer algorithm then produces an XSL template which creates a RML node that gets called the number of times equal to the number of items in the group. Now, a second example of the generalization will be described that includes an example of the input file, an example of the file after generalization and the final stylesheet.

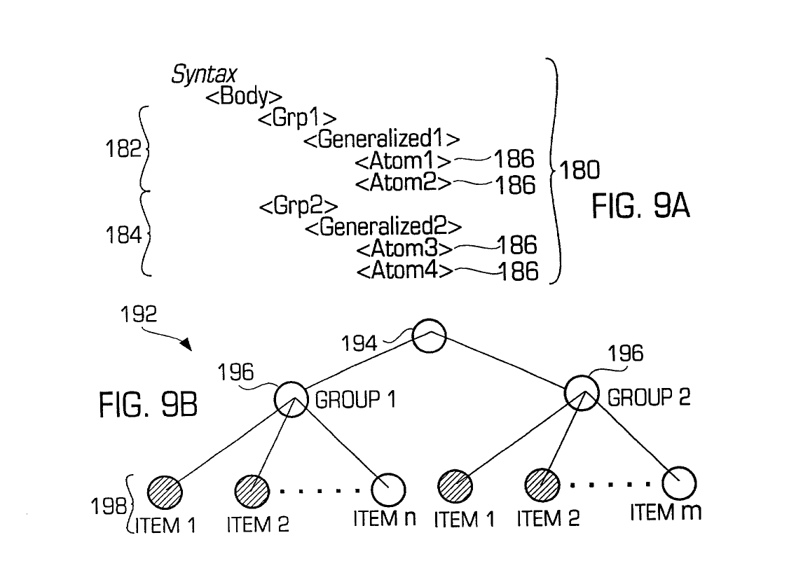

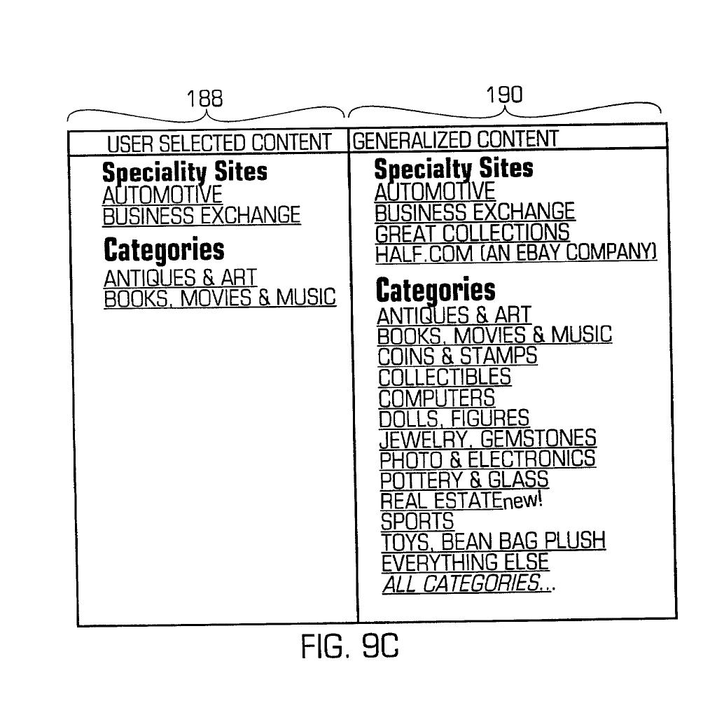

FIGS. 9A-9C illustrate a second generalizer example for generalizing atomics within a group (or multiple groups) in accordance with the invention. FIG. 9a illustrates a syntax 180 for generalizing atomics within multiple groups wherein a body section may include a first group 182 and a second group 184 and each group may have one or more atomics 186 as shown. As with case 1, the user may select at least two atomics from each group to generalize the group in accordance with the invention.

As shown in FIG. 9b, a list of user selected content 188 and a list of generalized content 190 are shown. As stated above, the user selects at least two pieces of content from each group (e.g., “Automotive” and “Business Exchange” from the “Specialty Sites” group and “Antiques & Art” and “Books, Movies & Music” from the “Categories” group. As a results of the selection by the user, the generalized content 190 may be extracted from a web page wherein the template for each atomic in the group is called the number of times (e.g., 4 for the “Specialty Sites” group and 14 for the “Categories” group. FIG. 9C illustrates a tree representation 192 of the elements in a web page including a root node 194, two group nodes 196 and multiple atomic nodes 198. The user selected atomics are shown as shaded nodes.

This is the case where multiple groups (two groups in FIG. 9b) from different places in an XHTML document, each containing varying number of items, need to be generalized. The groups do not generally have any relationship and so the only convenient way is to generalize the items from each group separately as shown above. Now, an example of the code input to the generalizer, an example of the code after generalization and an example of the final stylesheet that processes the elements in the groups in accordance with the invention are described.

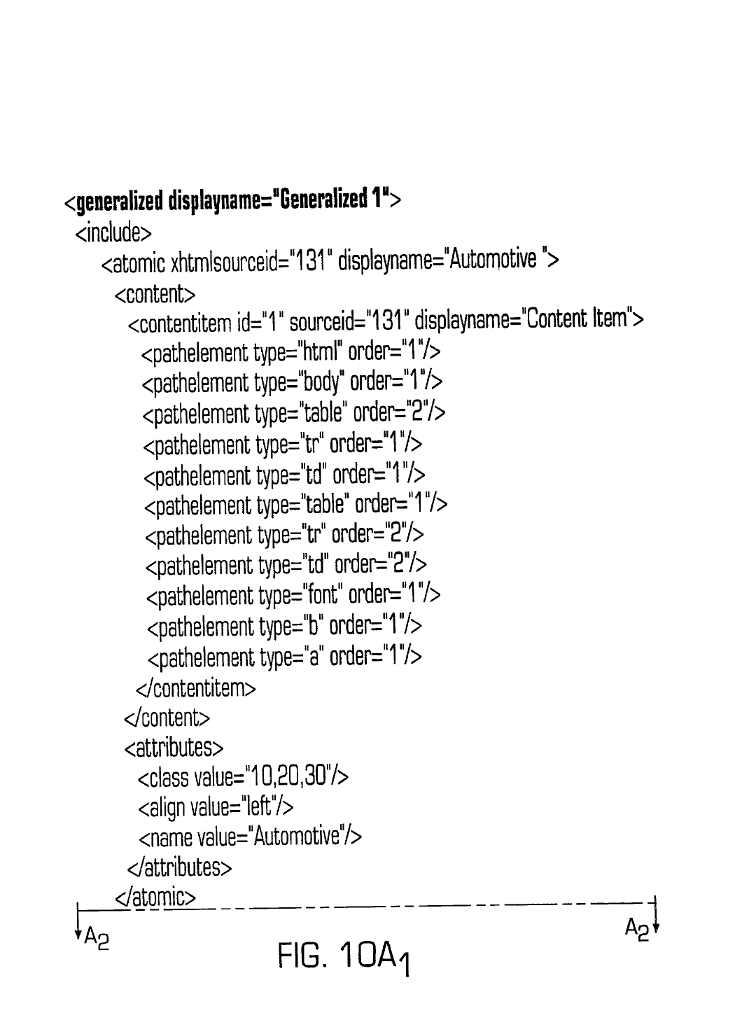

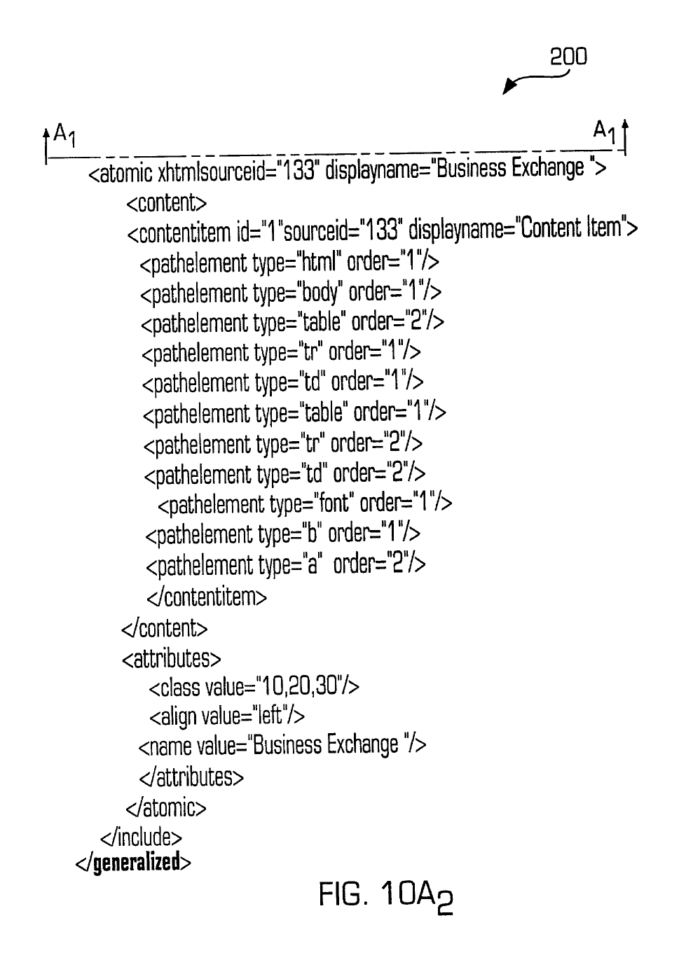

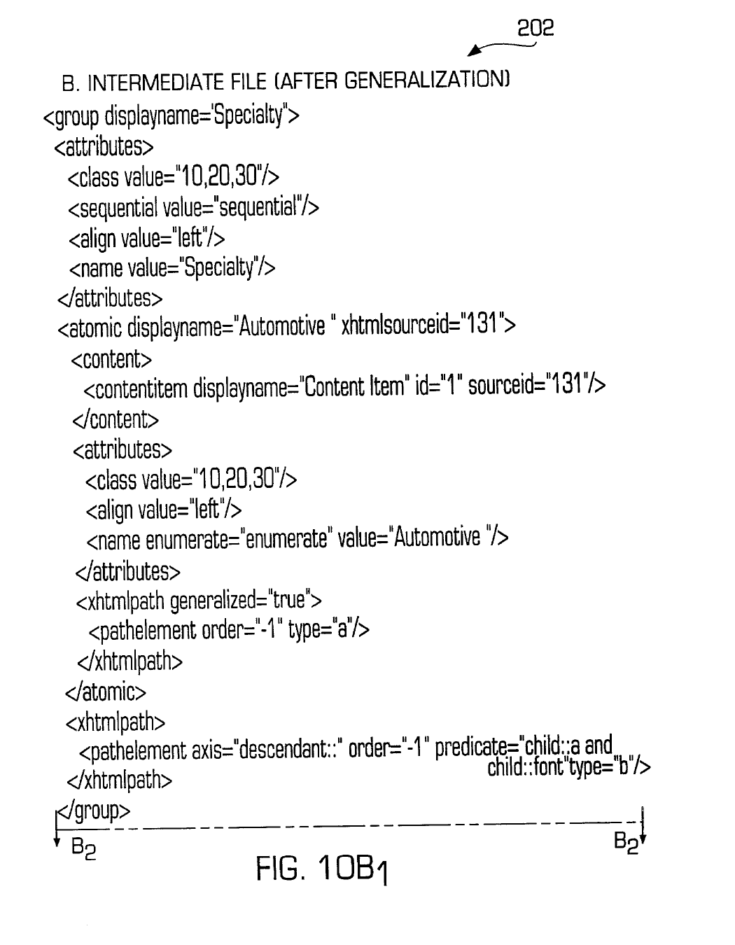

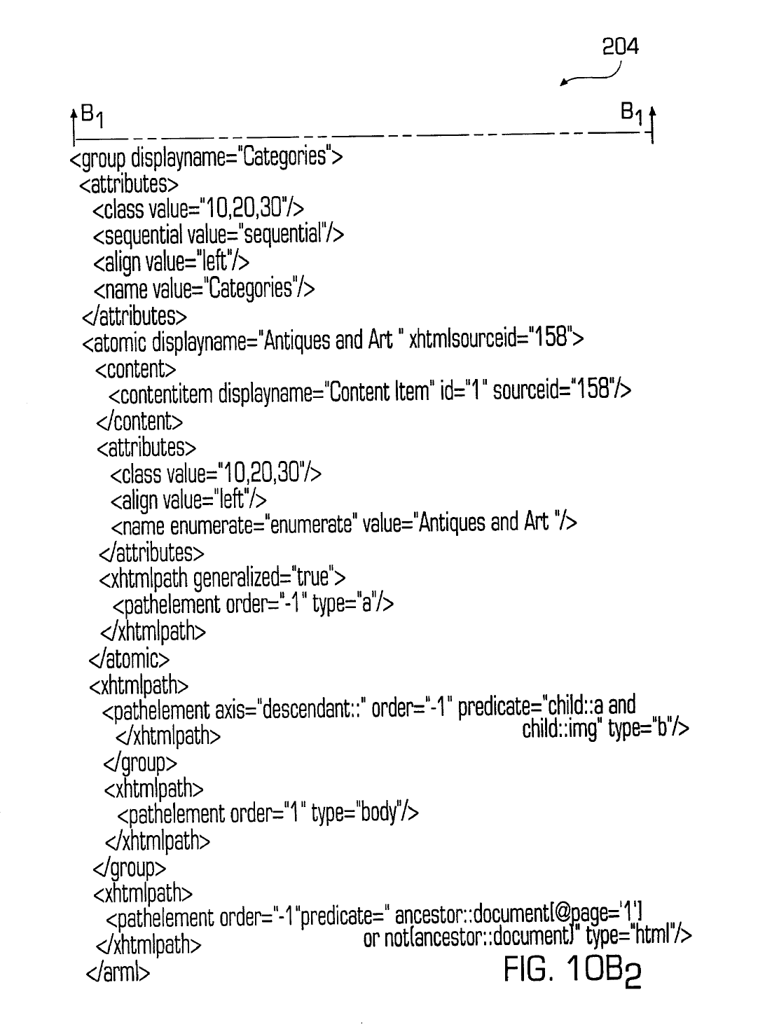

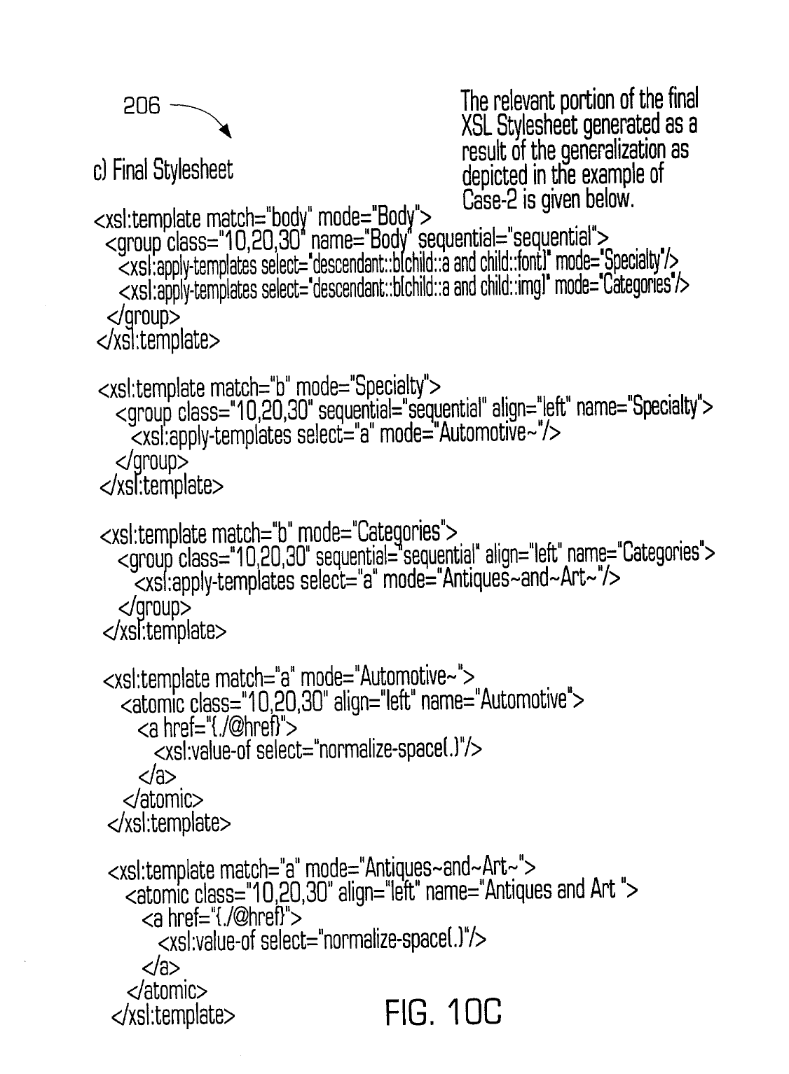

FIGS. 10A-10C illustrates more details of the second example of the generalization shown in FIGS. 9A-9C including examples of the initial formatted code, the generalized code and the stylesheet used to generalize the multiple atomics. For example, FIG. 10a is an example of a formatted code section 200 corresponding to the portion of the formatted code containing the information about the first generalized group “Specialty Sites” as shown in FIG. 9B. In this example, the input formatted file may be an ARML file that may be used with the wireless web page generation system described above. FIG. 10b illustrates a first portion 202 of code that is generalized code for the first group (“Specialty Sites”) and a second portion 204 of code that is the generalized code for the second group (“Categories”). The generalized code from each portion may include xhtmlpath element that provides the information about how to locate the atomics in the group. FIG. 10c illustrates a portion 206 of the XSL stylesheet used for the wireless web page generation system to generate wireless web pages. The XSL stylesheet will properly process a web page having the two groups and the atomics in each group. Now, another example of the generalization process will be described.

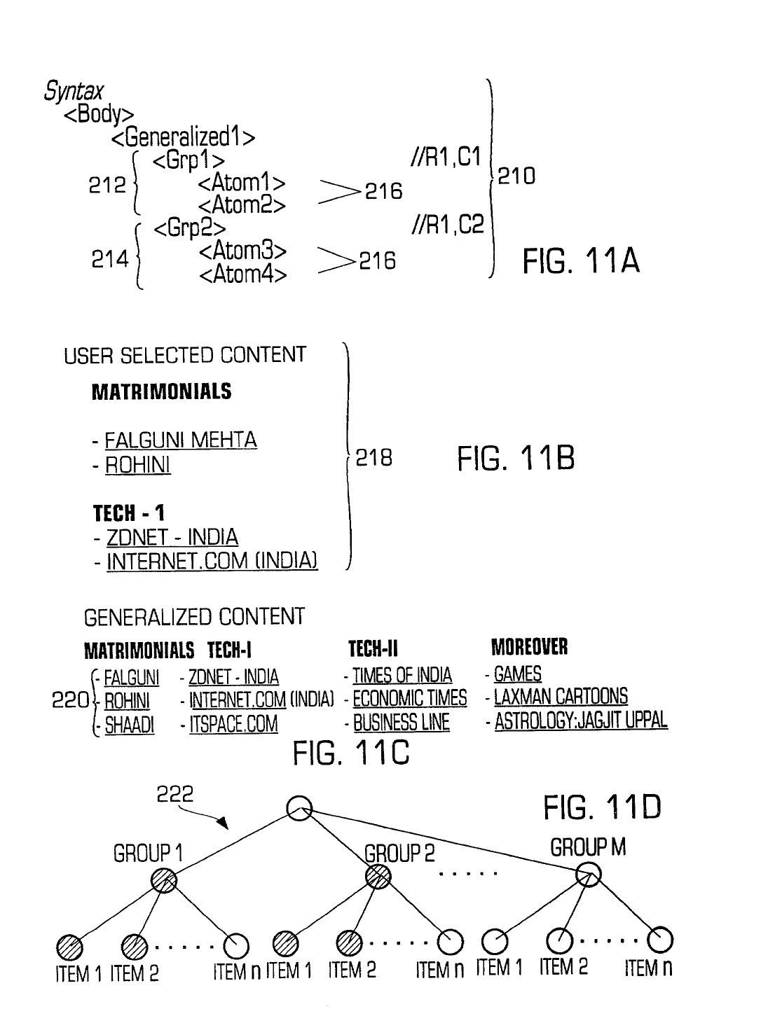

FIGS. 11A-11D illustrate a third generalizer example for generalizing multiple groups in a row-wise manner in accordance with the invention. FIG. 11a illustrates a syntax 210 of the groups including a first group 212 and a second group 214 wherein each group has rows and columns and each group has atomics 216 as shown. In this case, to generalize the multiple groups, a user may select at least two groups that each have the same number of elements. As shown in FIG. 11b, user selected content 218 is shown while generalized content 220 is shown in FIG. 11c. As shown in FIG. 11b, a user has selected the “Matrimonial” group and the “Tech-I” group and at least two items in each group. The content that needs to be generalized based on these user selections is shown in FIG. 11c wherein there are one or more groups representing columns in a table and the elements are arranges in a row-wise manner. FIG. 11d illustrates a tree 222 including the multiple groups with multiple elements wherein the user selected groups and user selected elements in each group are shaded.

Using the generalizer system in accordance with the invention, the above content may be generalized. Here the XHTML page contains a number of columns of groups with each group having the same number of items as shown above. In this case, it is possible to generalize at a group level called (row-wise generalization) rather than an item level. As described above, a user selects two columns of groups to generalize all columns. The number of items generalized per group will depend on the number of items per group chosen by the user. In the example above, only two items per group will be generalized.

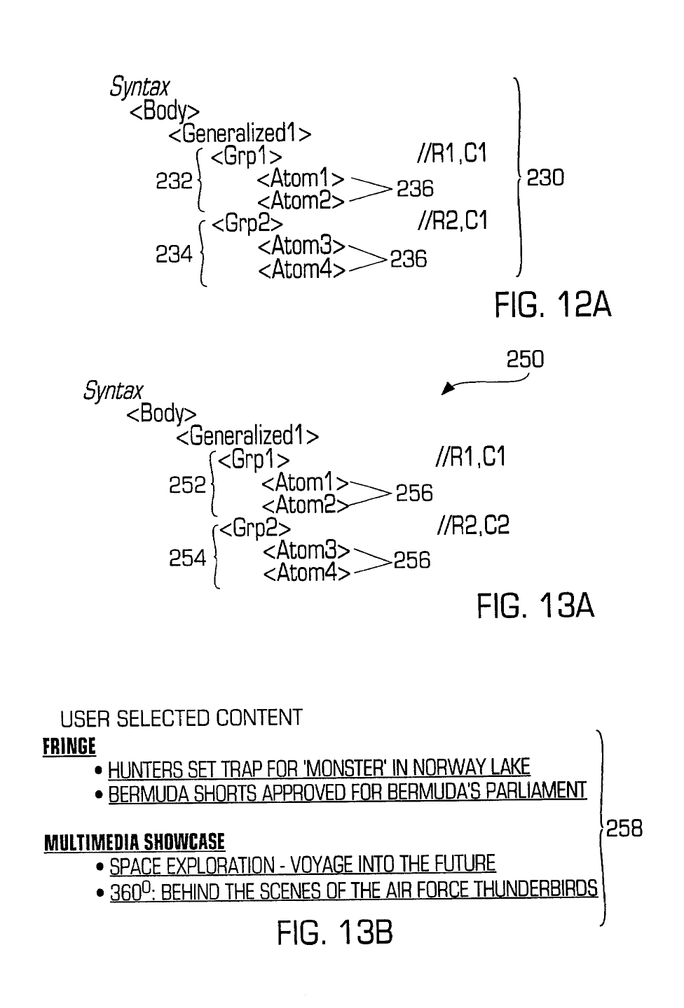

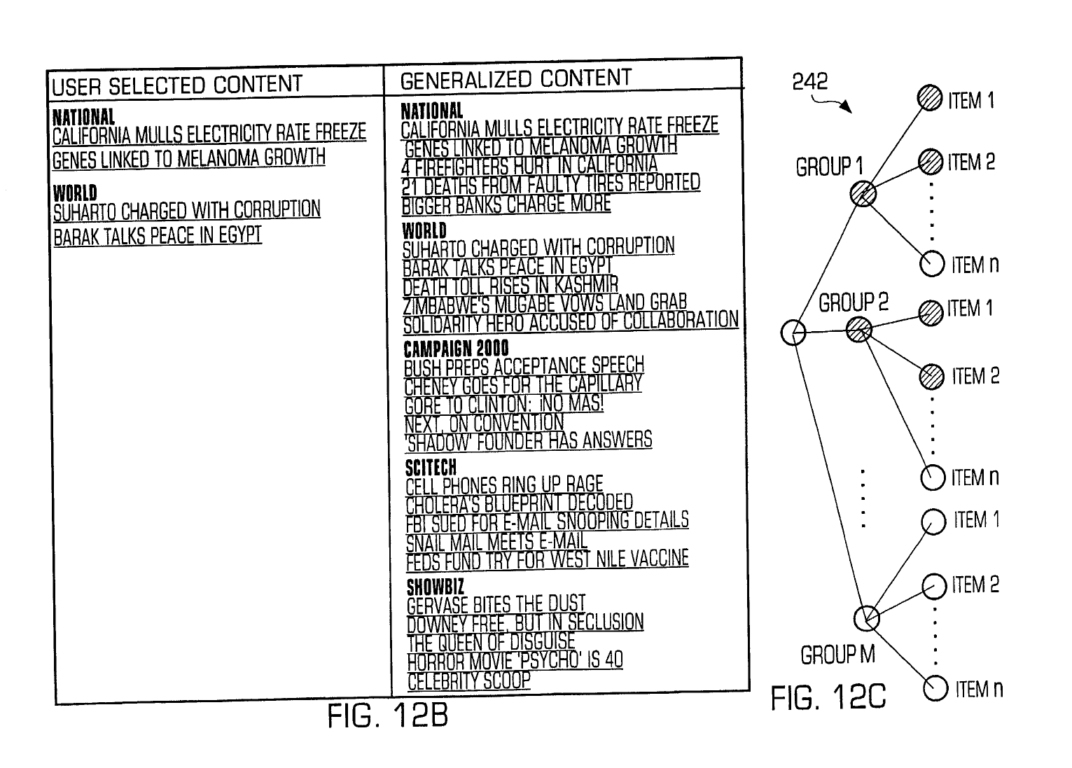

FIGS. 12A-12C illustrate a fourth generalizer example for generalizing multiple groups in a column-wise manner in accordance with the invention. FIG. 12a illustrates a syntax 230 of the groups including a first group 232 and a second group 234 wherein each group has rows and columns and each group has atomics 236 as shown. As above, to generalize the multiple groups, a user may select at least two groups that each have the same number of elements. As shown in FIG. 11b, user selected content 238 and generalized content 240 are shown. As shown in FIG. 11b, a user has selected the “National” group and the “World” group and at least two items (stories in this example) in each group. FIG. 11c illustrates a tree 242 including the multiple groups with multiple elements wherein the user selected groups and user selected elements in each group are shaded.

Here the XHTML page contains a number of rows of groups with each group having the same number of items as shown above. In this case, it is possible to generalize at a group level (column-wise generalization) rather than an item level. User selects two rows of groups to generalize. The number of items generalized per group will depend on the number of items per group chosen by the user. In the example above, only two items per group will be generalized.

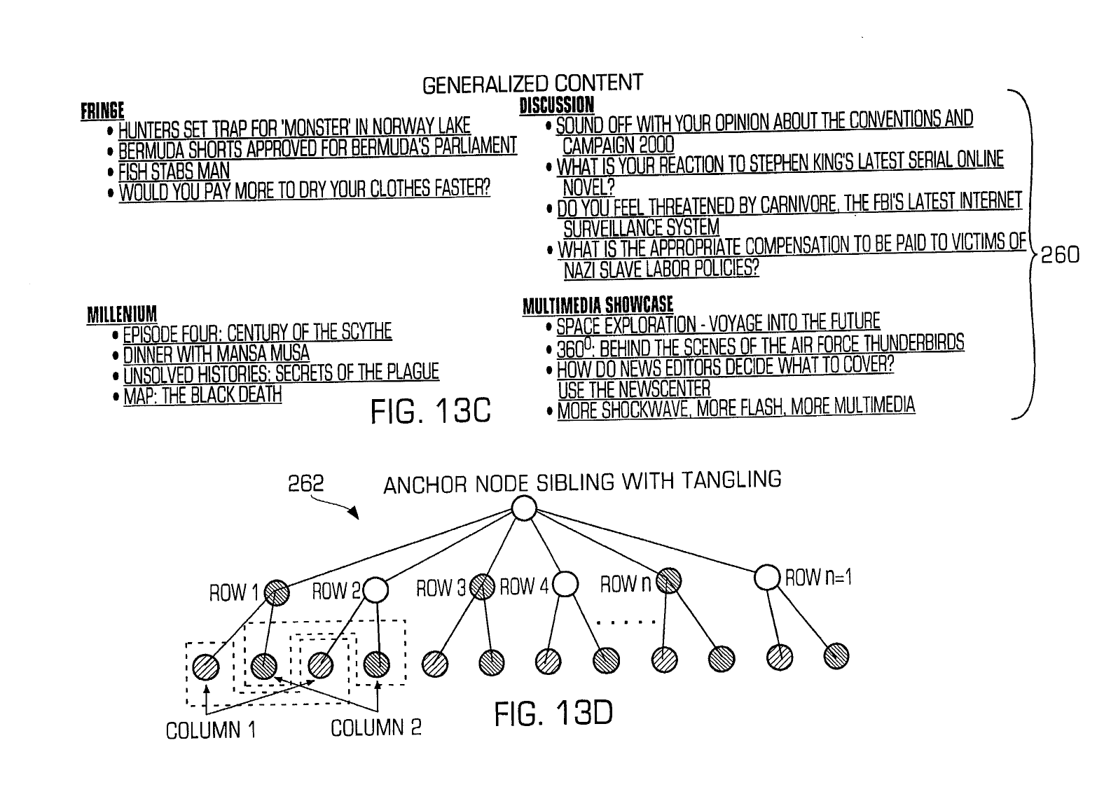

FIGS. 13A-13D illustrate a fifth generalizer example for generalizing multiple groups with multiple atomics using diagonal generalization in accordance with the invention. FIG. 13a illustrates a syntax 250 of the groups including a first group 252 and a second group 254 wherein each group has rows and columns and each group has atomics 256 as shown. As above, to generalize the multiple groups, a user may select at least two groups that each have the same number of elements. As shown in FIG. 13b, user selected content 258 is shown and FIG. 13c shows generalized content 260. As shown in FIG. 11b, a user has selected the “Fringe” group and the “Multimedia Showcase” group and at least two items (stories in this example) in each group. FIG. 13d illustrates a tree 262 including the multiple groups with multiple elements wherein the user selected groups and user selected elements in each group are shaded.

Here the XHTML page contains a table of groups with each group having the same number of items as shown above. In this case, it is possible to generalize at a group level (diagonal generalization) rather than an item level. User selects two diagonal groups to generalize. The number of items generalized per group will depend on the number of items per group chosen by the user. In the example above, only two items per group will be generalized.

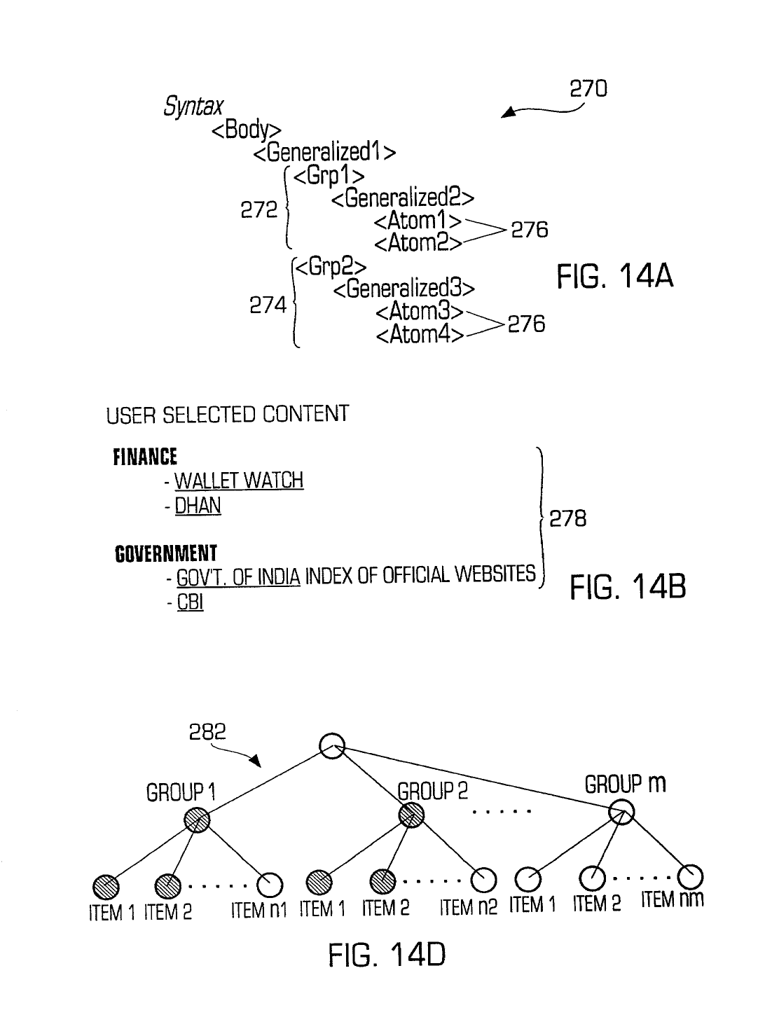

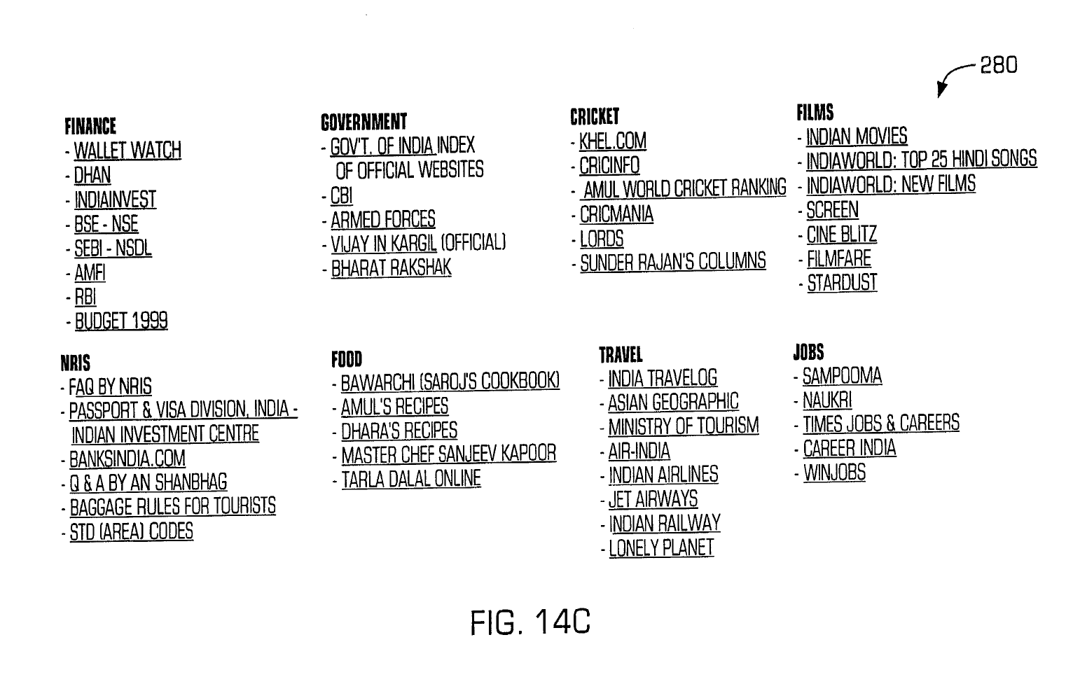

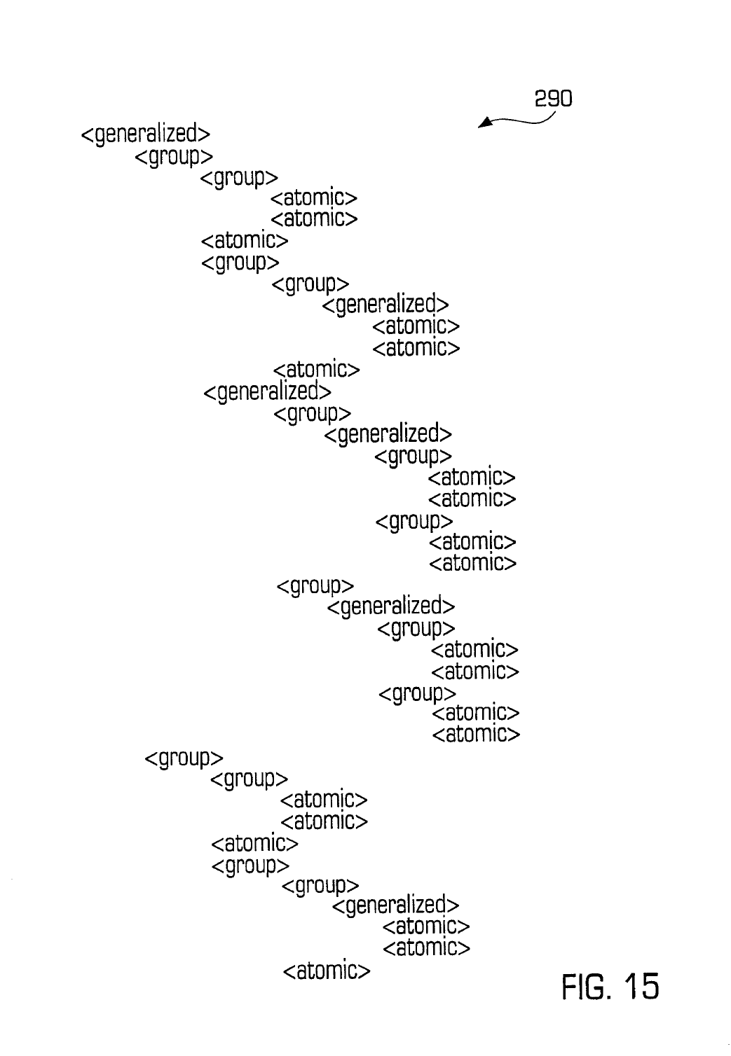

FIGS. 14A-14D illustrate a sixth generalizer example for generalizing multiple groups with multiple atomics using nested generalization in accordance with the invention. FIG. 14a illustrates a syntax 270 of the groups including a first group 272 and a second group 274 wherein each group has rows and columns and each group has atomics 276 as shown. As above, to generalize the multiple groups, a user may select at least two groups having at least two atomics. As shown in FIG. 14b, user selected content 278 is shown and FIG. 14c shows generalized content 280. As shown in FIG. 14b, a user has selected the “Finance” group and the “Government” group and at least two items in each group. FIG. 14d illustrates a tree 282 including the multiple groups with multiple elements wherein the user selected groups and user selected elements in each group are shaded.

Here the XHTML page contains a table of groups with each group having varying number of items as shown above. In this case, two levels of generalization are necessary, both at an item level generalization as well as a group level generalization. This is called the nested generalization. Item level generalization handles the varying number of items within each group whereas group level generalization handles the varying number of groups in the table.

FIG. 15 illustrate a seventh generalizer example for generalizing multilevel nested generalization with any combinations in accordance with the invention. In particular, a piece of content 290 may include multilevel nested groups as shown in FIG. 15. The selection of content and the generalized content is not shown for this example, but can be inferred from the above examples. It is also possible to generalize any structure, and nest generalization an unlimited number of times. For example, a group structure is generalized which contains two groups, an atomic and a generalized group as children. One group of the two contains two atomics, while the other contains a group which contains a generalized atomic and a normal atomic. The generalized group contains a generalized group which contains two atomics.

While the foregoing has been with reference to a particular embodiment of the invention, it will be appreciated by those skilled in the art that changes in this embodiment may be made without departing from the principles and spirit of the invention.

1. A system for processing a document having a varying number of pieces of content in a hierarchical document structure, the system comprising:
means for identifying an anchor node, the anchor node being a context node of a template for a particular node of content;
means for generating a location expression corresponding to the anchor node, the location expression locating one or more pieces of similar content identified by the anchor node; and
means for processing the document using the location expression, wherein the location expression is used each time a piece of content corresponding to the anchor node is located in the document so that the document with a varying number of pieces of content underneath the anchor node in the hierarchical document structure are properly processed.

2. The system of claim 1 further comprising means for identifying an anchor node parent with sibling case where particular nodes of content share the same anchor node and the path expressions for each particular node of content are the same as the anchor node, means for determining the anchors if the anchor node parent with sibling case is identified, means for combining the location expressions of the identified nodes of content into a single location expression for a generalized anchor node, means for determining if the generalized anchor node is a sibling, and means for generating a generalized expression corresponding to the generalized anchor node that locates the content in the particular nodes of content identified.

3. The system of claim 2 further comprising means for reanchoring the particular nodes of content to a reanchor node if the generalized anchor node is a sibling node and means for determining if the reanchor node is tangled such that the location expression to a piece of content matches more than one piece of content.

4. The system of claim 2 further comprising means for identifying the lowest node in the hierarchical document structure that has not been generalized and means for generalizing the lowest node before generalizing the nodes that are higher in the hierarchical document structure.

5. The system of claim 2, wherein the location expression combining means further comprises means for identifying a location expression for each particular node of content, means for determining if there are other nodes of content and means for generating a replacement anchor node if there are no other nodes of content.

6. The system of claim 5, wherein the location expression combining means further comprises means for determining if the location expression for the other nodes of content have been generalized, means for generalizing the location expressions of the other nodes of content if they have not been previously generalized and means for identifying the previously generalized location expressions.

7. The system of claim 6, wherein the location expression combining means further comprises means for determining if the code associated with the location expression are consistent with each other, means for generalizing each element of a location expression if the code is not consistent and means for generalizing the common elements in the path if the code is consistent.

8. The system of claim 3, wherein the means for determining a tangled node further comprises means for determining the anchor nodes in the hierarchical document structure and means for generating replacement nodes for location expressions having the same number of elements if there are no more anchor nodes.

9. The system of claim 8, wherein the means for determining a tangled node further comprises means for determining the number of elements in each location expression and means for indexing each location expression according to location, anchor number and element number.

10. A method for processing a document having a varying number of pieces of content in a hierarchical document structure, the method comprising:
identifying an anchor node, the anchor node being a context node of a template for a particular node of content;
generating a location expression corresponding to the anchor node, the location expression locating one or more pieces of similar content identified by the anchor node; and
processing the document using the location expression, wherein the location expression is used each time a piece of content corresponding to the anchor node is located in the document so that the document with a varying number of pieces of content underneath the anchor node in the hierarchical document structure are properly processed.

11. The method of claim 10 further comprising identifying an anchor node parent with sibling case where particular nodes of content share the same anchor node and the path expressions for each particular node of content are the same as the anchor node, determining the anchors if the anchor node parent with sibling case is identified, combining the location expressions of the identified nodes of content into a single location expression for a generalized anchor node, determining if the generalized anchor node is a sibling, and generating a generalized expression corresponding to the generalized anchor node that locates the content in the particular nodes of content identified.

12. The method of claim 11 further comprising reanchoring the particular nodes of content to a reanchor node if the generalized anchor node is a sibling node and determining if the reanchor node is tangled such that the location expression to a piece of content matches more than one piece of content.

13. The method of claim 11 further comprising identifying the lowest node in the hierarchical document structure that has not been generalized and generalizing the lowest node before generalizing the nodes that are higher in the hierarchical document structure.

14. The method of claim 11, wherein the location expression combining further comprises identifying a location expression for each particular node of content, determining if there are other nodes of content and generating a replacement anchor node if there are no other nodes of content.

15. The method of claim 14, wherein the location expression combining further comprises determining if the location expression for the other nodes of content have been generalized, generalizing the location expressions of the other nodes of content if they have not been previously generalized and identifying the previously generalized location expressions.

16. The method of claim 15, wherein the location expression combining further comprises determining if the code associated with the location expression are consistent with each other, generalizing each element of a location expression if the code is not consistent and generalizing the common elements in the path if the code is consistent.

17. The method of claim 12, wherein determining a tangled node further comprises determining the anchor nodes in the hierarchical document structure and generating replacement nodes for location expressions having the same number of elements if there are no more anchor nodes.

18. The method of claim 17, wherein the determining a tangled node further comprises determining the number of elements in each location expression and indexing each location expression according to location, anchor number and element number.

19. A system for generalizing a set of atomics and/or groups in a hierarchical document structure, the system comprising:
means for identifying an anchor node, the anchor node being a context node of a template for a particular node of content;
means for identifying an anchor node parent with sibling case where particular nodes of content share the same anchor node and the path expressions for each particular node of content are the same as the anchor node;
means for determining the anchors if the anchor node parent with sibling case is identified;
means for combining the location expressions of the identified nodes of content into a single location expression for a generalized anchor node;
means for determining if the generalized anchor node is a sibling; and
means for generating a generalized expression corresponding to the generalized anchor node that locates the content in the particular nodes of content identified.

20. The system of claim 19 further comprising means for reanchoring the particular nodes of content to a reanchor node if the generalized anchor node is a sibling node and means for determining if the reanchor node is tangled such that the location expression to a piece of content matches more than one piece of content.

21. The system of claim 19 further comprising means for identifying the lowest node in the hierarchical document structure that has not been generalized and means for generalizing the lowest node before generalizing the nodes that are higher in the hierarchical document structure.

22. The system of claim 19, wherein the location expression combining means further comprises means for identifying a location expression for each particular node of content, means for determining if there are other nodes of content and means for generating a replacement anchor node if there are no other nodes of content.

23. The system of claim 22, wherein the location expression combining means further comprises means for determining if the location expression for the other nodes of content have been generalized, means for generalizing the location expressions of the other nodes of content if they have not been previously generalized and means for identifying the previously generalized location expressions.

24. The system of claim 23, wherein the location expression combining means further comprises means for determining if the code associated with the location expression are consistent with each other, means for generalizing each element of a location expression if the code is not consistent and means for generalizing the common elements in the path if the code is consistent.

25. The system of claim 20, wherein the means for determining a tangled node further comprises means for determining the anchor nodes in the hierarchical document structure and means for generating replacement nodes for location expressions having the same number of elements if there are no more anchor nodes.

26. The system of claim 25, wherein the means for determining a tangled node further comprises means for determining the number of elements in each location expression and means for indexing each location expression according to location, anchor number and element number.

27. A method for generalizing a set of atomics and/or groups in a hierarchical document structure, the method comprising:
identifying an anchor node, the anchor node being a context node of a template for a particular node of content;
identifying an anchor node parent with sibling case where particular nodes of content share the same anchor node and the path expressions for each particular node of content are the same as the anchor node;
determining the anchors if the anchor node parent with sibling case is identified;
combining the location expressions of the identified nodes of content into a single location expression for a generalized anchor node;
determining if the generalized anchor node is a sibling; and
generating a generalized expression corresponding to the generalized anchor node that locates the content in the particular nodes of content identified.

28. The method of claim 27 further comprising reanchoring the particular nodes of content to a reanchor node if the generalized anchor node is a sibling node and determining if the reanchor node is tangled such that the location expression to a piece of content matches more than one piece of content.

29. The method of claim 27 further comprising identifying the lowest node in the hierarchical document structure that has not been generalized and generalizing the lowest node before generalizing the nodes that are higher in the hierarchical document structure.

30. The method of claim 27, wherein the location expression combining further comprises identifying a location expression for each particular node of content, determining if there are other nodes of content and generating a replacement anchor node if there are no other nodes of content.

31. The method of claim 30, wherein the location expression combining further comprises determining if the location expression for the other nodes of content have been generalized, generalizing the location expressions of the other nodes of content if they have not been previously generalized and identifying the previously generalized location expressions.

32. The method of claim 31, wherein the location expression combining further comprises determining if the code associated with the location expression are consistent with each other, generalizing each element of a location expression if the code is not consistent and generalizing the common elements in the path if the code is consistent.

33. The method of claim 28, wherein determining a tangled node further comprises determining the anchor nodes in the hierarchical document structure and generating replacement nodes for location expressions having the same number of elements if there are no more anchor nodes.

34. The method of claim 33, wherein the determining a tangled node further comprises determining the number of elements in each location expression and indexing each location expression according to location, anchor number and element number.

35. A system for generalizing a set of atomics and/or groups in a hierarchical document structure, the system comprising:
means for identifying an anchor node, the anchor node being a context XHTML node of the XSL template for a particular RML node;
means for identifying an anchor node parent with sibling delimiters where, each item shares the same parent;
means for identifying an anchor node sibling where, each individual area of generalized structure is not capable of being contained underneath its own unique ancestor node;
means for identifying an anchor node sibling with tangling where due to the way tables are structured in HTML;
means for generating an XPath expression that represent a set of selected nodes in an XHTML page, the number of which might change from page to page or from time to time; and
means for generating a generalized XPath expression for a set of atomics and/or groups in an XHTML page.

36. A method for generalizing a set of atomics and/or groups in a hierarchical document structure, the method comprising:
identifying an anchor node, the anchor node being a context XHTML node of the XSL template for a particular RML node;
identifying an anchor node parent with sibling delimiters where, each item shares the same parent;
identifying an anchor node sibling where, each individual area of generalized structure is not capable of being contained underneath its own unique ancestor node;
identifying an anchor node sibling with tangling where due to the way tables are structured in HTML;
generating an XPath expression that represent a set of selected nodes in an XHTML page, the number of which might change from page to page or from time to time; and generating a generalized XPath expression for a set of atomics and/or groups in an XHTML page.
